(19) United States
(12) Patent Application Publication
(10) Pub. No.: US 2013/0187747 A1
(43) Pub. Date: Jul. 25, 2013

(54) FUSE TERMINAL

(71) Applicant: Heinz Reibke, Bad Salzuflen (DE)

(72) Inventor: Heinz Reibke, Bad Salzuflen (DE)

(73) Assignee: PHOENIX CONTACT GmbH & Co. KG, Blomberg (DE)

(21) Appl. No.: 13/558,263

(22) Filed: Jul. 25, 2012

(30) Foreign Application Priority Data
Jul. 27, 2011 (DE) 10 2011 052 198.4

(51) Int. Cl. H01H 85/22

(52) U.S. Cl. CPC H01H 85/22
USPC 337/213

(57) ABSTRACT

The aim in the case of a fuse terminal is to reduce the terminal spacing and to improve handling. This is achieved by the fuse terminal having a housing, a fuse carrier, which is arranged in a pivotable manner on the housing, and a fuse element, wherein the fuse carrier has a pivoting arm, on which an accommodating element, in which the fuse element is inserted, is arranged such that the fuse element has its longitudinal axis arranged at an angle of essentially 90° to the longitudinal axis of the pivoting arm, and therefore the fuse element can be introduced, by means of a pivoting movement of the fuse carrier, into an opening formed vertically in the housing.

This application claims priority to German Patent Application Number DE 10 2011 052 198.4, titled SICHERUNGSKLEMME filed on Jul. 27, 2011, the entire contents of which is hereby incorporated herein by reference.

The invention is directed to a fuse terminal.

Fuse terminals, which can be arranged in a row one beside the other on a carrying rail, serve to provide the necessary fuse protection for main and control circuits in switchgear or switching stations, control means and equipment. Fuse terminals therefore have the task of providing protection and distributing a potential.

The prior art discloses, for example, fuse terminals in which the fuse element has a screw cap screwed vertically into the housing of the fuse terminal. The disadvantage here is that a large terminal spacing of 12 mm is necessary. In addition, handling in order to insert the fuse element in the fuse terminal, and release the same, is laborious.

It is therefore the object of the invention to provide a fuse terminal by means of which the terminal spacing is reduced and handling of the fuse terminal can be simplified.

In the case of a fuse terminal of the type referred to in more detail in the introduction, this object is achieved according to the invention by the fuse terminal having a housing, a fuse carrier, which is arranged in a pivotable manner on the housing, and a fuse element, wherein the fuse carrier has a pivoting arm, on which an accommodating element, in which the fuse element is inserted, is arranged such that the fuse element has its longitudinal axis arranged at an angle of essentially 90° to the longitudinal axis of the pivoting arm, and therefore the fuse element can be introduced, by means of a pivoting movement of the fuse carrier, into an opening formed vertically in the housing.

Expedient configurations and advantageous developments of the invention are specified in the dependent claims.

The fuse terminal according to the invention is distinguished in that the fuse element is now no longer screwed, by means of a screw cap, in an opening formed in the housing; rather, it is pivoted into the opening by means of a pivoting arm of a fuse carrier, in order for the fuse element to be positioned in the opening of the housing. The fuse element, for this purpose, is arranged in an accommodating element formed on the pivoting arm. The fuse carrier, or the pivoting arm of the fuse carrier, is arranged or mounted in a pivotable manner on the housing, and therefore the fuse element arranged in the accommodating element of the fuse carrier is mounted directly on the housing in captive fashion, via the fuse carrier, even if the fuse element has not been introduced into the opening of the housing. Arranging the fuse element on the housing in a pivotable manner via the fuse carrier, in addition, allows simplified handling when the fuse element is being introduced into the opening of the housing and when the fuse element is being removed from the opening of the housing. The accommodating element, together with which the fuse element can be introduced into the opening of the housing, is preferably adapted to the contour and/or the outer dimensions of the fuse element and butts directly against the outer circumferential surface of the fuse element, and therefore the smallest possible additional amount of installation space is needed in the fuse terminal for the accommodating element. The accommodating element is designed preferably in the manner of a cage, which encloses only certain regions of the fuse element and does not cover the entire outer circumferential surface of the fuse element. According to the invention, the fuse element, and thus also the accommodating element, has its longitudinal axis arranged at an angle of essentially 90° to the longitudinal axis of the pivoting arm, and therefore the fuse element can be arranged, by pivoting, vertically in the housing. Arranging the fuse element vertically in the housing causes the width of the fuse terminal to be affected hardly at all by the fuse element, and therefore the overall size of the fuse terminal can be as small as possible, with the smallest possible width. Arranging the fuse element vertically in the housing means that the fuse element has its longitudinal axis arranged at an angle of 90° to the upper side and to the underside of the housing of the fuse terminal, the latter being latched on a carrying rail by way of this upper side and/or underside. The same also applies to the opening formed vertically in the housing. The fuse terminal according to the invention thus makes it possible to reduce the terminal spacing of the fuse terminal, to simplify handling and to reduce the overall size of the fuse terminal as far as possible. It is also possible for a plurality of such fuse terminals to be integrated with the same contour in existing terminal type series.

According to a preferred configuration of the invention, the housing contains a first contact element which, with the fuse element in a state in which it has been introduced into the opening, makes contact with the fuse element at a first end, and a second contact element, which, with the fuse element in the state in which it has been introduced into the opening, makes contact with a second end of the fuse element, the second end being located opposite the first end. The two contact elements are preferably each connected to a conductor-connection body, which may be designed in the form, for example, of a screw-connection body or solder-connection body. The connection takes place preferably by way of a metal strip which extends from one contact element to a conductor-connection body assigned to the contact element, and projects preferably into the conductor-connection body, and therefore the metal strip, and thus the contact element, can come into contact directly, via the metal strip, with a conductor which has been introduced in the conductor-connection body. A metallic contact cap, against which the contact elements can butt in contact, is arranged preferably in each case at the first end and the second end of the fuse element. It is thus possible to connect two contact elements, and thus also two conductor-connection bodies, to a fuse element.

Furthermore, it is preferably provided that the first contact element and the second contact element are of essentially u-shaped design, and the first contact element and the second contact element engage around the fuse element, in the introduced state, in each case along its outer circumference. The contact elements here are formed preferably from a metal strip or metal band which is bent in a u-shaped manner. The u-shaped configuration of the contact elements allows the fuse element to be retained in a clamped state in the contact elements between two U-forming contact arms without further additional components being necessary here. The contact elements are thus distinguished by a straightforward configuration in which it is possible to ensure, at the same time, reliable contact between the contact elements and the fuse element by the u-shaped contact elements engaging around the fuse element, in the introduced state, in each case along its outer circumference, wherein the outer circumference is formed preferably by the contact caps arranged at the two ends of the fuse element.

The first essentially u-shaped contact element and the second essentially u-shaped contact element further preferably each have an introduction opening for accommodating the fuse element, via which the fuse element can be introduced into the first contact element and the second contact element, wherein the cross-sectional surface area of the introduction opening of the first contact element is formed perpendicularly to the cross-sectional surface area of the introduction opening of the second contact element. The introduction openings of the first contact element and of the second contact element are thus preferably not oriented in the same direction; rather they are turned at an angle of 90° in relation to one another. The two contact elements here are preferably arranged in the housing such that the fuse element has the end-side surface of its first end butting, in the introduced state, against the first contact element, and therefore the first contact element engages around the fuse element along its longitudinal axis. The second contact element, in contrast, engages around the fuse element in the direction transverse to its longitudinal axis, and therefore the fuse element has its longitudinal-side surface butting, in the introduced state, against the second contact element. This allows the fuse element to be retained in the two contact elements such that it is particularly secured against slipping, in order for it to be possible to ensure reliable contact even in the event of vibrations or during transportation of the fuse terminal.

The accommodating element is preferably designed such that the accommodating element has two bar elements, which are arranged opposite one another and between which the fuse element is retained in a clamped state. Forming the accommodating element essentially from the two bar elements means that the outer circumferential surface of the fuse element is covered by the accommodating element only over a relatively small region, and therefore the possible contact surface area of the fuse element for contact with the contact elements is as large as possible. In addition, the accommodating element thus has a straightforward configuration requiring only a small amount of installation space, and the fuse element, in addition, can easily be introduced into the accommodating element and released from the accommodating element again.

In order for the fuse element to be retained securely in the retaining element, the two bar elements preferably each have a latching-in region for clamping the fuse element.

In order, furthermore, to facilitate handling of the fuse terminal for a user, it is preferably provided that the fuse carrier has a grip element, which is arranged on the pivoting arm. The grip element is arranged preferably at a free end of the pivoting arm and is preferably in the form of a bar which is arranged on the pivoting arm at an angle, i.e. at an angle of preferably 5°-60°, to the longitudinal axis of the pivoting arm. The grip element also preferably has a ribbed side surface, in order to prevent slippage of the grip element during actuation of the fuse carrier and thus to improve handling of the fuse terminal.

In addition, according to a preferred configuration of the invention, it is provided that the fuse carrier has a marking surface, via which the fuse terminal can be identified. The marking surface is formed preferably on the pivoting arm of the fuse carrier, and therefore the marking surface is clearly evident to a user.

The invention will be explained in more detail hereinbelow by way of a preferred embodiment of the invention and with reference to the accompanying drawings, in which:

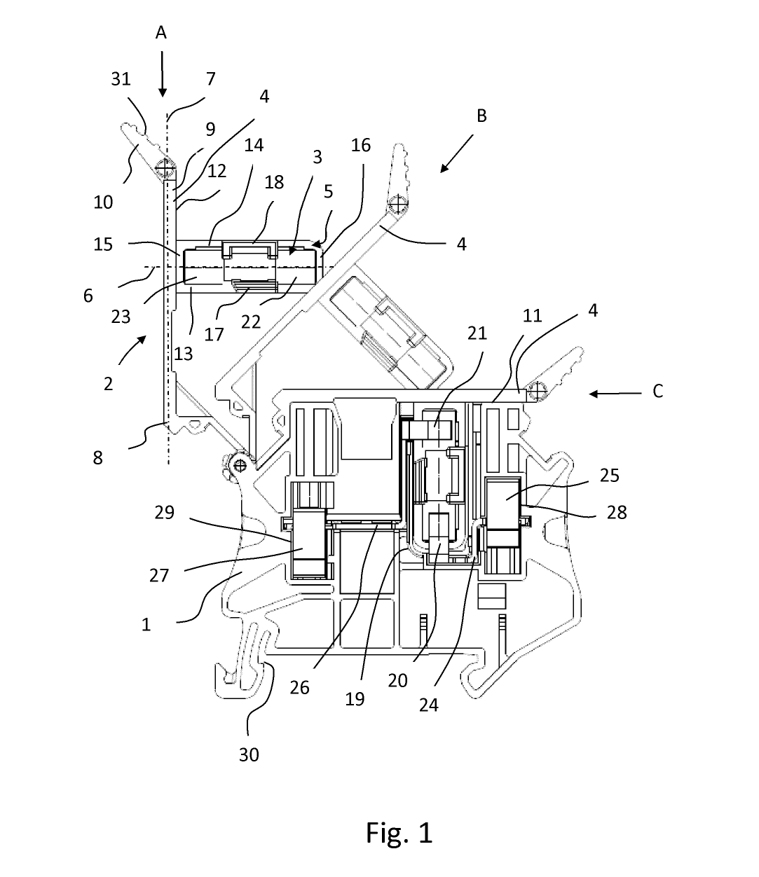

FIG. 1 shows a schematically illustrated side view of a fuse terminal according to the invention with the fuse carrier of the fuse terminal in three different positions, and

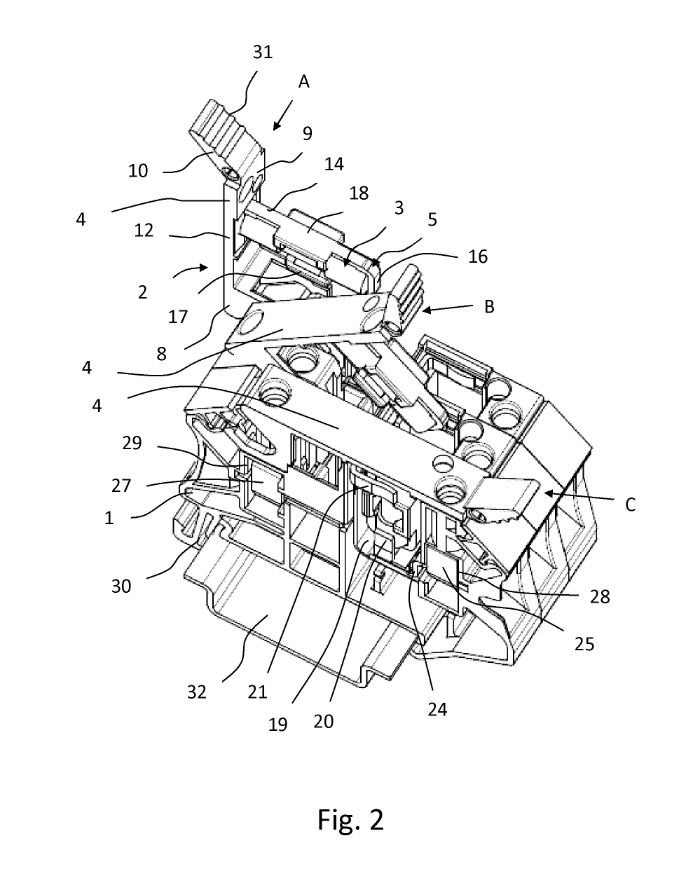

FIG. 2 shows a schematically illustrated perspective view of the fuse terminal shown in FIG. 1.

FIGS. 1 and 2 show fuse terminals according to the invention, FIG. 2 showing three fuse terminals latched one beside the other here on a carrying rail 32. Each fuse terminal respectively has a housing 1, in particular an insulating-material housing, a fuse carrier 2, which is arranged in a pivotable manner on the housing 1, and a fuse element 3, which is arranged in the fuse carrier 2. The fuse carrier 2 has a pivoting arm 4, on which is arranged an accommodating element 5, in which the fuse element 3 is inserted. The accommodating element 5 is arranged on the pivoting arm 4 such that the fuse element 3 has its longitudinal axis 6 arranged at an angle of 90° to the longitudinal axis 7 of the pivoting arm 4. The pivoting arm 4 of the fuse carrier 2 has a first end 8 and a second end 9, wherein the pivoting arm 4 has its first end 8 mounted in a rotatable manner on the housing 1. A grip element 10 is arranged at the second end 9 of the pivoting arm 4, this second end being located opposite the first end 8. The pivoting arm 4 is in the form of an elongate bar or bracket, which is approximately equal to the width of the housing 1, and therefore the pivoting arm 4 can cover over the upper side 11 of the housing 1. The pivoting arm 4, the accommodating element 5 and the grip element 10 are formed from a non-conductive plastics material. The accommodating element 5 is arranged on an underside 12 of the pivoting arm 4, this underside, with the fuse element 3 in a state in which it has been introduced into the housing 1, resting on the upper side 11 of the housing 1.

The accommodating element 5 is of rectangular design and comprises essentially two bar elements 13, 14, arranged parallel to each other, between which the fuse element 3 is retained in the clamped state. The two bar elements 13, 14 extend along the longitudinal-side surfaces of the fuse element 3. The two bar elements 13, 14 are connected to a first connecting bar 15 and a second connecting bar 16, which is located opposite the first connecting bar 15, wherein the fuse element 3 has its two end-side surfaces butting against a respective connecting bar 15, 16. The region between the two bar elements 13, 14 is free, and therefore the fuse element is not covered by the accommodating element 5 in these regions of its longitudinal-side surface. In order for it to be possible for the fuse element 3 to be retained securely in the covering element 5, the two bar elements 13, 14 each have a latching-in region 17, 18 for clamping the fuse element 3. The two latching-in regions 17, 18 are formed opposite one another on the two bar elements 13, 14. The two latching-in regions 17, 18 are each wider than the bar elements 13, 14, and therefore, in the region of the latching-in regions 17, 18, a relatively large surface area of the outer circumference of the fuse element 3 is covered and butts against the outer circumference. That surface of the latching-in regions 17, 18 which is oriented in the direction of the fuse element 3 is curved, and therefore the latching-in regions 17, 18 are adapted to the cylindrical outer circumference of the fuse element 3 and, consequently, the fuse element 3 can be fastened in the accommodating element 5 so as not to tilt. The latching-in regions 17, 18 are positioned such that they retain the fuse element 3 centrally.

FIGS. 1 and 2 show the fuse carrier 2 in three different positions. In the first position A, the fuse carrier 2 is raised up from the upper side 11 of the housing 1 and pivoted away from the housing 1. In the position B, the fuse carrier 2 is arranged in an intermediate position. In the position C, the pivoting arm 4 of the fuse carrier 2 rests on the upper side 11 of the housing 1 and the accommodating element 5 has been introduced, together with the fuse element 3, into an opening 19 formed vertically in the housing 1. Position C thus shows the fuse element 3 in an introduced state. In the introduced state, the fuse element 3 has been introduced or incorporated fully into the housing 1, wherein the fuse element 3, in this position C, is arranged perpendicularly, i.e. at an angle of 90°, to the upper side 11 of the housing 1.

The housing 1, in the region of the opening 19, contains a first contact element 20 and a second contact element 21, wherein, in the introduced state of the fuse element 3, the first contact element 20 makes contact with the fuse element 3 at a first end 22 and the second contact element 21 makes contact with the fuse element 3 at a second end 23, which is located opposite the first end 22. In order for contact to be made, a contact cap is arranged preferably at the first end 22, and at the second end 23, of the fuse element 3, the contact elements 20, 21 butting against this contact cap when contact is being made.

The first contact element 20 and the second contact element 21 are of essentially u-shaped design, and therefore, when contact is being made, they engage around the outer circumference, or outer circumferential surface, of the fuse element 3. The first and second contact elements 20, 21 are each formed from a metal strip or metal band which is bent in a u-shaped manner. The u-shaped contact elements 20, each have an introduction opening, via which the fuse element 3 is introduced into the first contact element 20 and the second contact element 21 in the event of a pivoting movement of the fuse carrier 2, wherein the cross-sectional surface area of the introduction opening of the first contact element 20 is formed perpendicularly to the cross-sectional surface area of the introduction opening of the second contact element 21. The contact elements 20, 21 are thus open in different directions from one another, via which the fuse element 3, together with the accommodating element 5, is pivoted into the contact elements 20, 21. The two contact elements 20, 21 are arranged in the housing 1 such that the fuse element 3 has the end-side surface of its first end 22 butting, in the introduced state, against the first contact element 20 and introduced into the U-shape of the first contact element 20, and therefore the first contact element 20 engages around the fuse element 3 along its longitudinal axis 6. The second contact element 21, in contrast, engages around the fuse element 3 in the direction transverse with respect to its longitudinal axis 6, and therefore the fuse element 3 has its longitudinal-side surface butting, in the introduced state, against the second contact element 21.

The first contact element 20 is connected to a first conductor-connection body 25 via a metal strip 24. The second contact element 21 is connected to a second conductor-connection body 27 via a metal strip 26. The metal strips 24, 26 here are designed to be of such a length as to be guided through in each case one opening 28, 29, formed in the conductor-connection bodies 25, and in which a conductor can be clamped, and to project beyond the same.

The housing 1 of the fuse terminal can be latched, via the latching mount 30, onto a carrying rail 32, as shown in FIG. 2.

The grip element 10 of the fuse carrier 2 is arranged on the pivoting arm 4 at an angle, i.e. at an angle of preferably 5°-60°, to the longitudinal axis 7 of the pivoting arm 4. For better handling of the grip element 10 on the part of a user, the grip element 10 has a ribbed side surface 31, in order to prevent slippage of the grip element 10 during actuation of the fuse carrier 2.

### LIST OF DESIGNATIONS

Housing 1
Fuse carrier 2
Fuse element 3
Pivoting arm 4
Accommodating element 5
Longitudinal axis 6
Longitudinal axis 7
First end 8
Second end 9
Grip element 10
Upper side 11
Underside 12
First bar element 13
Second bar element 14
First connecting bar 15
Second connecting bar 16
First latching-in region 17
Second latching-in region 18
Opening 19
First contact element 20
Second contact element 21
First end 22
Second end 23
Metal strip 24
First conductor-connection body 25
Metal strip 26
Second conductor-connection body 27
Opening 28
Opening 29
Latching mount 30
Side surface 31
Carrying rail 32
First position A
Second position B
Third position C

1. A fuse terminal having
a housing,
a fuse carrier, which is arranged in a pivotable manner on the housing, and
a fuse element,
wherein the fuse carrier has a pivoting arm, on which an accommodating element, in which the fuse element is inserted, is arranged such that the fuse element has its longitudinal axis arranged at an angle of essentially 90° to the longitudinal axis of the pivoting arm, and therefore the fuse element can be introduced, by means of a pivoting movement of the fuse carrier, into an opening formed vertically in the housing.

2. The fuse terminal as claimed in claim 1, wherein the housing contains a first contact element, which, with the fuse element in a state in which it has been introduced into the opening, makes contact with the fuse element at a first end, and a second contact element, which, with the fuse element in the state in which it has been introduced into the opening, makes contact with a second end of the fuse element, the second end being located opposite the first end.

3. The fuse terminal as claimed in claim 2, wherein the first contact element and the second contact element are essentially u-shaped, and the first contact element and the second contact element engage around the fuse element, in the introduced state, in each case along its outer circumference.

4. The fuse terminal as claimed in claim 3, wherein the first essentially u-shaped contact element and the second essentially u-shaped contact element each have an introduction opening for accommodating the fuse element, via which the fuse element can be introduced into the first contact element and the second contact element, wherein the cross-sectional surface area of the introduction opening of the first contact element is formed perpendicularly to the cross-sectional surface area of the introduction opening of the second contact element.

5. The fuse terminal as claimed in claim 1, wherein the accommodating element has two bar elements, which are arranged opposite one another and between which the fuse element is retained in a clamped state.

6. The fuse terminal as claimed in claim 2, wherein the accommodating element has two bar elements, which are arranged opposite one another and between which the fuse element is retained in a clamped state.

7. The fuse terminal as claimed in claim 3, wherein the accommodating element has two bar elements, which are arranged opposite one another and between which the fuse element is retained in a clamped state.

8. The fuse terminal as claimed in claim 4, wherein the accommodating element has two bar elements, which are arranged opposite one another and between which the fuse element is retained in a clamped state.

9. The fuse terminal as claimed in claim 5, wherein the two bar elements each have a latching-in region for clamping the fuse element.

10. The fuse terminal as claimed in claim 1, wherein the fuse carrier has a grip element, which is arranged on the pivoting arm.

11. The fuse terminal as claimed in claim 1, wherein the fuse carrier has a marking surface.
